(19) United States
(12) Patent Application Publication
(10) Pub. No.: US 2025/0138760 A1
(43) Pub. Date: May 1, 2025

(54) INFORMATION PROCESSING APPARATUS, MANAGEMENT SYSTEM, DEVICE REGISTRATION METHOD, AND RECORDING MEDIUM

(71) Applicant: Konica Minolta, Inc., Tokyo (JP)

(72) Inventors: Hiroyuki Ooyama, Tokyo (JP); Masatsugu Kouguchi, Tokyo (JP); Kazuma Maruyama, Tokyo (JP)

(73) Assignee: Konica Minolta, Inc., Tokyo (JP)

(21) Appl. No.: 18/925,433

(22) Filed: Oct. 24, 2024

(30) Foreign Application Priority Data
Oct. 27, 2023 (JP) 2023-184536

(51) Int. Cl. G06F 3/12

(52) U.S. Cl. CPC G06F 3/1236; G06F 3/1205; G06F 3/1211; G06F 3/1285

(57) ABSTRACT

Disclosed is an information processing apparatus including a hardware processor that detects a plurality of devices for printing connected to a communication network and registers the detected plurality of devices directly connected to each other as one printing system.

### BACKGROUND OF THE INVENTION

### Technical Field

The present invention relates to an information processing apparatus, a management system, a device registration method, and a recording medium.

### Description of Related Art

Conventionally, a printer search system has been known in which a personal computer searches for a printer satisfying desired conditions from among a plurality of printers on a communication network (see Japanese Unexamined Patent Publication No. 2002-259097).

Furthermore, a printing system including a print engine (image forming apparatus), an external controller, and the like is known. In a printing system on a communication network, a personal computer (PC) transmits a print job to an external controller when performing printing. The external controller generates image data for printing from a print job and causes the image forming apparatus to print the image data.

Therefore, when the PC registers a printing device on the communication network in an application program such as a driver, it is sufficient to register the external controller. Hereinafter, the application program is simply referred to as an application.

Furthermore, when executing an application for adjusting an image forming apparatus, a PC can search for image forming apparatus on a communication network and register them in the application. As described above, in a conventional application, the types of devices to be registered are limited depending on the purpose, as in the above-described printer search system. Therefore, it is not necessary to search for and register both the image forming apparatus and the external controller.

There is known an application that comprehensively adjusts and manages density and color misregistration of an image forming apparatus and colors of an external controller. However, it is necessary to register and manage a plurality of devices such as the application image forming apparatus and the external controller as one printing system. At that time, it is necessary to determine which of the plurality of image forming apparatuses and external controllers searched for on the communication network is connected as one printing system.

### SUMMARY OF THE INVENTION

An object of the present invention is to manage a plurality of printing devices on a communication network as one printing system.

To achieve at least one of the abovementioned objects, according to an aspect of the present invention, information processing apparatus reflecting one aspect of the present invention is an information processing apparatus comprising a hardware processor that:
detects a plurality of devices for printing connected to a communication network; and
registers the detected plurality of devices directly connected to each other as one printing system.

To achieve at least one of the abovementioned objects, according to another aspect of the present invention, management system reflecting one aspect of the present invention is a management system comprising:
the information processing apparatus; and
a plurality of devices connected to the communication network.

To achieve at least one of the abovementioned objects, according to another aspect of the present invention, device registration method reflecting one aspect of the present invention is a device registration method comprising:
detecting a plurality of devices for printing connected to a communication network; and
registering the detected plurality of devices directly connected to each other as one printing system.

To achieve at least one of the abovementioned objects, according to another aspect of the present invention, recording media reflecting one aspect of the present invention a non-transitory recording medium storing a computer readable program causing a computer to perform:
detecting a plurality of devices for printing connected to a communication network; and
registering the detected plurality of devices directly connected to each other as one printing system.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a block diagram illustrating a management system according to an embodiment of the present invention;

FIG. 2 is a block diagram illustrating an internal configuration of a PC;

FIG. 3 is a block diagram showing the internal configuration of the external controller;

FIG. 4 is a block diagram illustrating an internal configuration of the image forming apparatus;

FIG. 5 is a flowchart illustrating device registration processing;

FIG. 6 is a flowchart illustrating the device registration processing subsequent to FIG. 5;

FIG. 7 is a flowchart illustrating device registration processing subsequent to FIG. 6; and

FIG. 8 is a view illustrating a registration information display screen.

### DETAILED DESCRIPTION

Hereinafter, one or more embodiments of the present invention will be described with reference to the drawings. However, the scope of the invention is not limited to the disclosed embodiments.

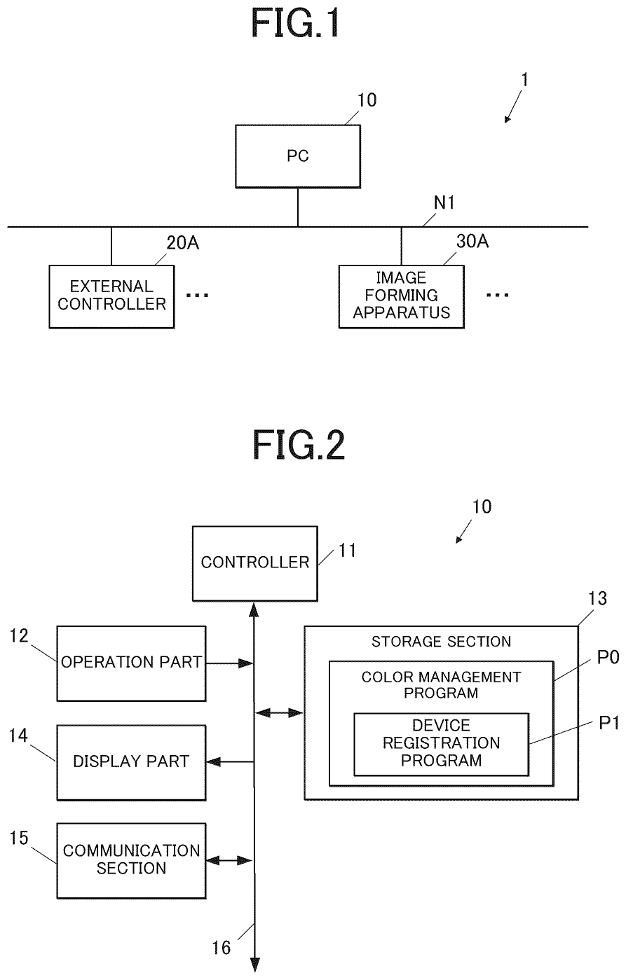

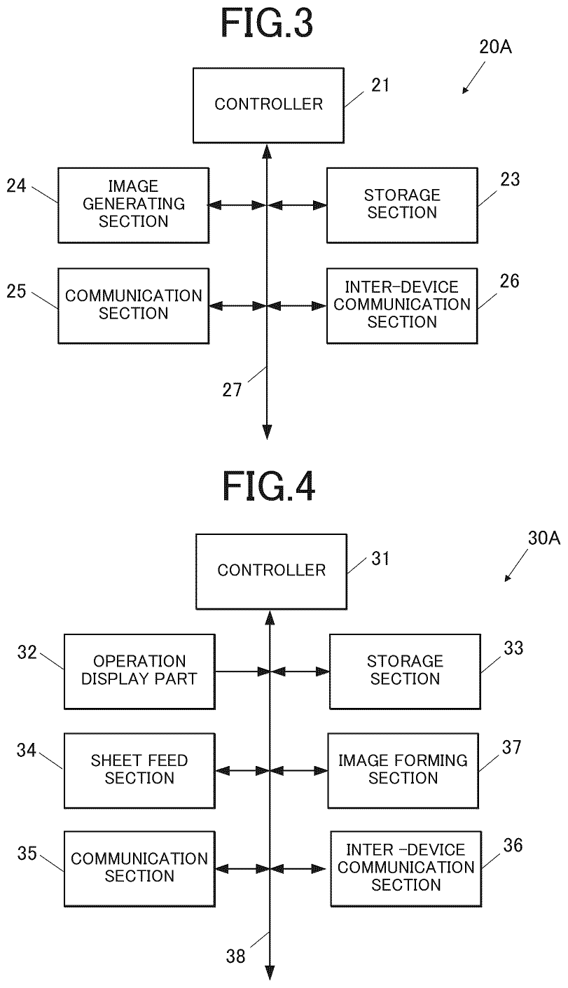

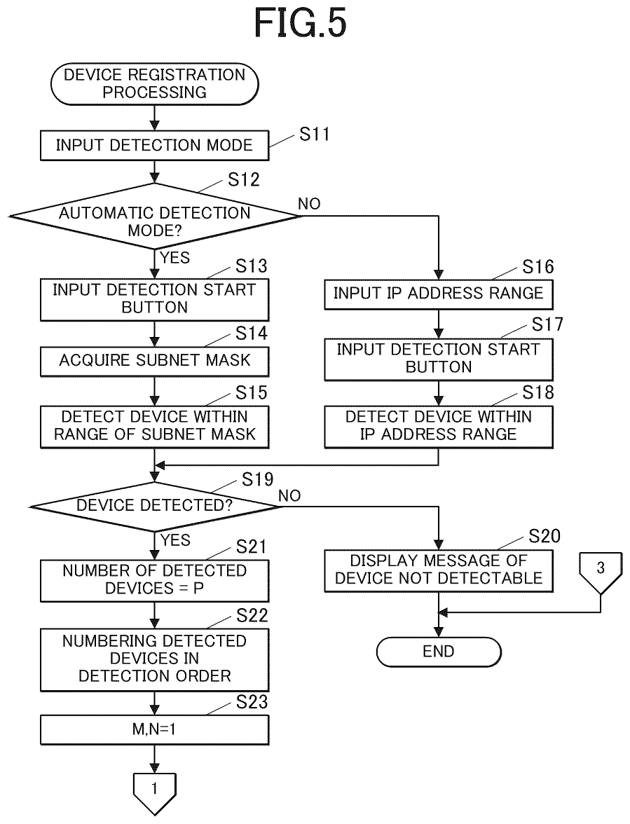

First, the device configuration according to the present embodiment will be described with reference to FIGS. 1 to 4. FIG. 1 is a block diagram illustrating a management system 1 according to an embodiment. FIG. 2 is a block diagram illustrating an internal configuration of PC10. FIG. 3 is a block diagram showing an internal configuration of the external controller 20A. FIG. 4 is a block diagram illustrating an internal configuration of the image forming apparatus 30A.

The management system 1 is an information processing system that manages a plurality of printing devices on a communication network. The management system 1 includes at least one printing system on a communication network. This printing system is a system that is connected to a communication network, is composed of a plurality of printing devices directly connected to each other, and forms (prints) an image on a sheet. The plurality of devices of the printing system are an external controller and an image forming apparatus.

As illustrated in FIG. 1, the management system 1 includes a PC10, an external controller 20A—, and an image forming apparatus 30A—on a communication network N1. The communication network N1 is, for example, a local area network (LAN) connected to the Internet. A device connected to the communication network N1 is assigned a unique Internet Protocol (IP address.

The PC10 is an information processor that manages devices on the communication network N1. The external controller 20A—is an external controller as at least one image generation device on the communication network N1. Upon receiving a print job from the external controller PC10 or the like, each external controller performs image processing such as RIP (Raster Image Processor) processing on image data included in the print job. Each external controller generates image data for printing by image processing, and transmits the image data to one of the image forming apparatuses 30A—Here, among the external controllers 20A—, the external controller 20A will be described as a representative, but the same applies to the other external controllers.

The image forming apparatus 30A—is an image forming apparatus as at least one print engine on the communication network N1. Each image forming apparatus forms (prints) an image on a sheet based on a print job input from the image forming apparatus PC10 or image data transmitted from each external controller. Here, the image forming apparatus 30A will be described as a representative of the image forming apparatuses 30A—, but the same applies to the other image forming apparatus.

An internal functional configuration of PC10 will be described with reference to FIG. 2. The PC10 includes a controller 11 (hardware processor) as a detection unit, a registration unit, and a setting unit, an operation part 12, a storage section 13, a display part 14, and a communication section 15. Each unit of the PC10 is connected via a bus 16.

The controller 11 controls each part of the PC10. The controller 11 includes a central processing unit (CPU), a random access memory (RAM), and the like. In the controller 11, the CPU reads a program stored in the storage section 13, loads the program to the RAM, and performs various types of processing in accordance with the loaded program.

In particular, the controller 11 executes a device registration processing, which will be described later, according to the device registration program P1 in the color management program P0 stored in the storage section 13. The color management program P0 is installed on an operating System (OS). The color management program P0 is a program for managing the printing color and the like of the device on the communication network N1. The color management program P0 has an external controller adjustment function, an image forming apparatus adjustment function, and the like. The external controller adjustment performs color correction or the like by calibration or profiling of the external controller. The image forming apparatus adjustment function adjusts the maximum density and the density balance of the image forming apparatus. By these functions, color reproduction optimum for a print product can be performed. The device registration program P1 is a program for detecting a device such as an external controller or an image forming apparatus connected to the communication network N1 and registering the device as one printing system.

The operation part 12 includes a keyboard and a pointing device such as a mouse. The operation part 12 outputs, to the controller 11, operation information such as key input information and position information input by the user.

The storage section 13 includes a hard disk drive (HDD) and a solid state drive (SSD) and stores various types of data and various programs in a readable and writable manner. In particular, the storage section 13 stores a color management program P0 as an application.

The display part 14 includes a display panel such as a liquid crystal display (LCD) and an electro-luminescence (EL) display.

The display part 14 displays display information from the controller 11 or the like on the display panel. The communication section 15 is a communication interface that includes a network card or the like and communicates with the communication network N1. The controller 11 transmits and receives information to and from the devices on the communication network N1 (such as the external controller 20A—and the image forming apparatus 30A—) via the communication section 15.

The internal functional configuration of the external controller 20A will be described with reference to FIG. 3. The external controller 20A includes a controller 21, a storage section 23, an image generating section 24, a communication section 25, and an inter-device communication section 26. Each unit of the external controller 20A is connected via a bus 27.

The controller 21 controls each unit of the external controller 20A. The controller 21 includes a CPU, a RAM, and the like. In the controller 21, the CPU reads a program stored in the storage section 23, develops the program in the RAM, and executes various types of processing in accordance with the developed program.

The storage section 23 includes an HDD, an SSD, a flash memory, and the like, and stores various data such as image data and various programs in a readable and writable manner.

The image generating section 24 performs image processing such as RIP processing on image-data to be printed in a print job received from PC10 or the like to generate (convert) image-data for printing.

The communication section 25 includes a network card or the like, and is a communication interface that communicates with the communication network N1. The controller 21 transmits and receives information to and from devices on the communication network N1 (PC10, image forming apparatus 30A—, and the like) through the communication section 25.

The inter-device communication section 26 is a communication interface that performs direct communication with the image forming apparatus without involving the communication network N1. The controller 21 transmits and receives information to and from the image forming apparatus in the same printing system through the inter-device communication section 26. The communication of the inter-device communication section 26 is, for example, communication via a peer-to-peer cable (e.g., a LAN cable) and a video cable.

With reference to FIG. 4, the internal functional configuration of the image forming apparatus 30A will be described. The image forming apparatus 30A includes a controller 31, an operation display part 32, a storage section 33, a sheet feed section 34, an image forming section 37, a communication section 35, and an inter-device communication section 36. Each unit of the image forming apparatus 30A is connected via a bus 38.

Controller 31 controls each part of image forming apparatus 30A. The controller 31 includes a CPU, a RAM, and the like. In the controller 31, the CPU reads a program stored in the storage section 33, develops the program in the RAM, and executes various types of processing in accordance with the developed program.

The operation display part 32 includes a display part having a display panel such as an LCD and an EL display, and an operation part such as a touch screen and a key operation part. The operation part of the operation display part 32 outputs operation information such as key input information and position information input by the user to the controller 31. The display part of the operation display part 32 displays various display information input from the controller 31 or the like on the display panel

The storage section 33 includes an HDD, an SSD, and a flash memory, and stores various kinds of data such as image data for printing and various programs in a readable and writable manner.

The sheet feed section 34 includes a mechanism unit such as a sheet ejection tray and a paper feed roller. The sheet feed section 34 supplies a sheet stored in a sheet feeding tray to the image forming section 37 under the control of the controller 31.

The image forming section 37 is an image forming section using a color electrophotographic method as an image forming method. The image forming section 37 includes mechanical units such as a conveyance roller, image forming units of Y (yellow), M (magenta), C (cyan), and K (black), an intermediate transfer belt, a fixing section, and a sheet ejection tray. Under the control of the controller 31, the image forming section 37 first conveys the sheet supplied from the sheet feed section 34 to the image forming units by the conveyance rollers. The image forming section 37 forms toner images of YMCK on the intermediate transfer belt by the image forming units of YMCK based on image data from the image forming section PC10 or an external controller. The image forming section 37 transfers the toner image on the intermediate transfer belt to a sheet, and the fixing section fixes the toner image on the sheet with heat and pressure. The image forming section 37 ejects the sheet with an image formed thereon as a printed product to a sheet ejection tray by the conveyance rollers.

The communication section 35 is a communication interface that includes a network card or the like and communicates with the communication network N1. The controller 31 transmits and receives information to and from the device (PC10, external controller 20A—, or the like) on the communication network N1 via the communication section 35.

The inter-device communication section 36 is a communication interface that directly communicates with an external controller without involving the communication network N1. The controller 21 transmits and receives information to and from an external controller in the same printing system via the inter-device communication section 26. The communication of the inter-device communication section 36 is, for example, communication via a peer-to-peer cable and a video cable.

The image forming apparatus 30A is not limited to the above-described configuration. For example, the image forming apparatus 30A may be configured to have a post-processing device, an image reading device, and the like. Furthermore, an image forming method of the image forming section 37 is not limited to a color electrophotographic method. The image forming method of the image forming section 37 may be another image forming method such as an inkjet method.

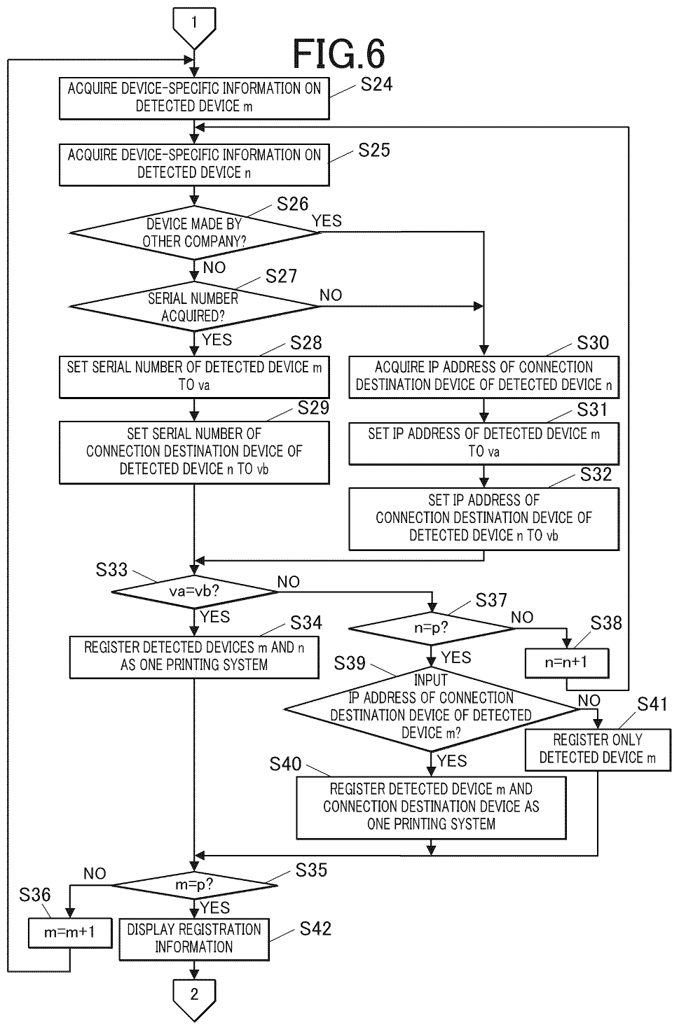

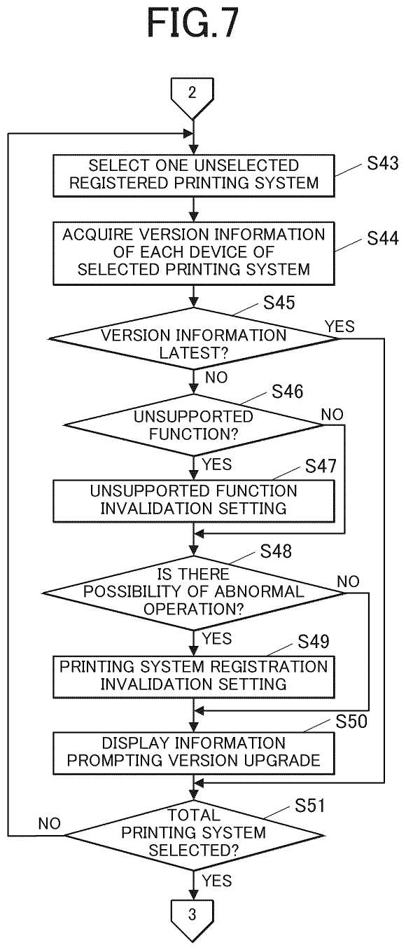

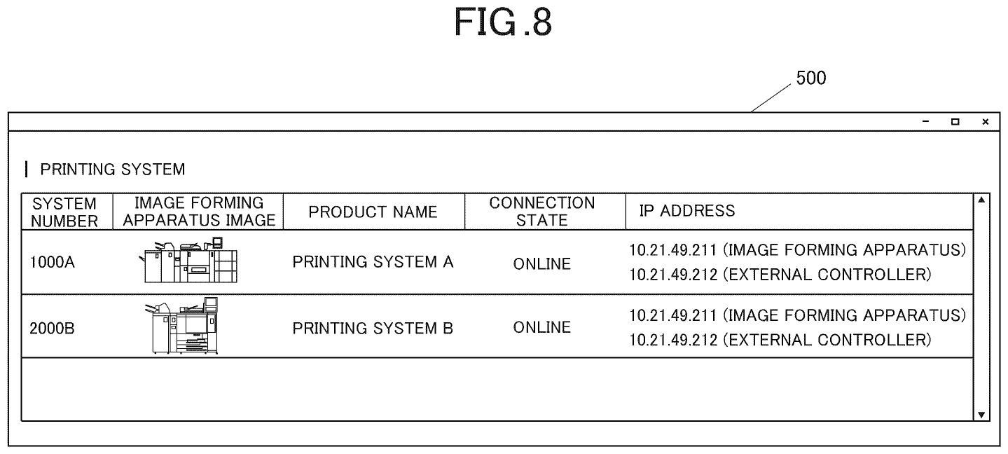

Next, the operation of the management system 1 will be described with reference to FIGS. 5 to 8. FIG. 5 is a flowchart illustrating device registration processing. FIG. 6 is a flowchart illustrating the device registration processing subsequent to FIG. 5. FIG. 7 is a flowchart illustrating the device registration processing subsequent to FIG. 6. FIG. 8 is a view illustrating a registration information display screen 500.

The image forming apparatus adjusts maximum density, density balance, and the like in order to achieve optimal color reproduction. Actual adjustment work is to operate an operation input part of the image forming apparatus to perform adjustment of the highest density, density balance, and the like. Alternatively, the actual adjustment work is adjustment work in which the image forming apparatus is remotely accessed from an application of a PC or the like.

The external controller also performs color correction by calibration or profiling to achieve optimum color reproduction. Actual adjustment work is to remotely connect to an external controller from a PC and perform calibration of the external controller.

Alternatively, the actual adjustment work is to register a profile created by performing color adjustment with an application of a PC or the like and perform color correction with an external controller based on the profile.

Optimum color reproduction can be achieved by adjusting the image forming apparatus and the external controller in consideration of the characteristics of a sheet to be used. Furthermore, the image forming apparatus and the external controller can be remotely connected from an application to perform adjustment. However, conventionally, adjustment of the image forming apparatus and adjustment of the external controller have been performed separately.

In the present embodiment, the adjustment of the image forming apparatus and the external controller is registered in one application. To realize a management system 1 for integrally managing colors by executing an application. Optimum color reproduction can be easily performed by performing adjustment in consideration of the characteristics of a sheet to be used by one application.

A printing system including two devices, i.e., an external controller and an image forming apparatus, each of which has a communication interface of a communication network will be considered. When managing this one printing system with an application, it is conceivable to simply detect (search for) and display a plurality of devices on a communication network when registering the devices. However, by simply displaying the detected device, it is not possible to know which image forming apparatus and which external controller are configured as the same printing system. Therefore, there is a problem that the device cannot be registered and managed as one printing system. An object of the present embodiment is to solve this problem.

In the management system 1, the external controller 20A—and the image forming apparatus 30A—connected to the communication network N1 constitute at least one printing system. In the present embodiment, a set (pair) of one external controller and one image forming apparatus directly connected to and interlocking with the external controller is defined as one printing system. In this printing system, a color management program P0 as an application is an object to manage print colors. However, the color management program P0 also manages a single image forming apparatus on the communication network N1, which is not configured as one printing system.

An external controller of the printing system generates image data for printing from a print job submitted from PC10. The image forming apparatus of the same printing system forms an image on a sheet based on the image data for printing. The single image forming apparatus of the printing system forms an image on a sheet on the basis of the print job input from PC10.

The device registration processing is executed by PC10. The device registration processing is a process of detecting (searching for) a plurality of devices of the printing system on the communication network N1 and registering the devices as one printing system in the registration information. In the PC10, for example, an instruction to perform the device registration processing is input from the user via the operation part 12. Triggered by the execution instruction, the controller 11 executes the device registration processing in accordance with the device registration program P1 stored in the storage section 13.

As illustrated in FIG. 5, first, the controller 11 receives an input of the detection mode from the user via the operation part 12 (step S11). The detection mode is a mode for setting a range of a communication network N1 in which a device of the printing system is detected (searched). The detection mode includes an automatic detection mode and a manual detection mode. The automatic detection mode is a mode in which the device is automatically detected in the detection range obtained from the information stored in PC10. The manual detection mode is a mode for detecting a device in a detection range input by the user.

The controller 11 determines whether the detection mode input in step S11 is the automatic detection mode (step S12). In a case where the mode is in the automatic detection mode (step S12; YES), the controller 11 receives, via the operation part 12, a click input of the displayed detection start button (step S13). The detection start button is a soft key that is displayed on the display part 14 and receives an input to start detection of a device (image forming apparatus, external controller) on the communication network N1.

The controller 11 refers to the network setting information stored in the storage section 13 of PC10, and acquires the subnet mask of the communication network range including PC10 (step S14). The controller 11 detects a device within the communication network range of the subnet mask acquired in step S14 in the communication network N1 (step S15).

In step S15, the controller 11 broadcasts a request for IP addresses to devices within the communication network range of the subnet mask. Then, the controller 11 receives a reply of the IP address from each device in the communication network range of the subnet mask, and detects the device that has received the reply. In step S15 and step S18 to be described later, when detecting a device, the controller 11 holds the detected device and the order of detection.

In the case of the manual detection mode (step S12; NO), the controller 11 receives an input of the range of IP addresses in the detection range of the device via the operation part 12 (step S16). The controller 11 receives a click input of the displayed detection start button via the operation part 12 (step S17). As in step S15, controller 11 detects a device in communication network N1 within the range of IP addresses input in step S16 (step S18).

After performing step S15 or S18, the controller 11 determines whether the device has been detected in step S15 or S18 (step S19). When the device is not detected (step S19; NO), the controller 11 displays a message indicating that the device cannot be detected on the display part 14 (step S20). The device registration processing ends.

When a device is detected (step S19; YES), the controller 11 substitutes the number of detected devices (detected devices) into a variable p (step S21). The controller 11 assigns numbers starting from 1 to the respective detected devices in the order of detection (step S22). The controller 11 assigns an initial value of 1 to the variables m and n (step S23). The variable m is a variable of the number of a device of a comparison source in a case where connection of two devices is determined. The variable n is also a variable of the number of the device to be compared. Here, it is assumed that the connection between the two devices is not a connection via the communication network N1 but a direct connection via the inter-device communication sections 26_and 36. The identification of the detected device is represented by variables m and n.

As illustrated in FIG. 6, the controller 11 transmits a request for device-specific information to the detected devices m and n via the communication section 15, and receives the device-specific information from the detected device m (step S24). The device-specific information is specific information that the device has. The device-specific information usually includes a serial number of the device and a serial number of a device to which the device is directly connected (referred to as a connection destination device). The controller 11 sends a request for the device-specific information to the detected device n via the communication section 15 and receives the device-specific information from the detected device n (step S25).

The controller 11 determines, from the device-specific information acquired in steps S24 and S25, whether the connection destination device of the detected device m or the detected device n is a device manufactured by another company than the predetermined company (step S26). The device-specific information includes a standard management information base (MIB) and a private MIB.

The private MIB of the device manufactured by the predetermined company includes a flag (off) of the device manufactured by the predetermined company and a serial number of the device manufactured by the predetermined company.

However, the private MIB of the device manufactured by another company includes the flag (off) of the device manufactured by a predetermined company, and does not include the serial number of the device manufactured by another company. That is, only a predetermined company uses a serial number for a private MIB.

In step S26, the controller 11 refers to the private MIB of the device-specific information acquired in steps S24 and S25. Thus, the controller 11 can determine whether or not at least one of the connection destination devices of the detected device m and the detected device n is a device manufactured by another company.

In a case where the connection destination devices of the detected device m and the detected device n are devices manufactured by a predetermined company (step S26; NO), the process proceeds to step S27. The controller 11 acquires the serial numbers of the detected device m and the connection destination device of the detected device n from the device-specific information acquired in steps S24 and S25 (step S27). Further, in step S27, the controller 11 determines whether or not these serial numbers have been acquired.

When the serial number is acquired (step S27; YES), the controller 11 sets the serial number of the detected device m to the variable va (step S28). The controller 11 sets the serial number of the connection destination device of the detected device n in a variable vb (step S29).

In a case where the connection destination device of the detected device m or the detected device n is a device manufactured by another company (step S26; YES), the process proceeds to step S30. The controller 11 acquires the IP addresses of the connection destination devices of the detected device n from the detected device n via the communication section 15 (step S30). If a serial number has not been acquired (step S27; NO), the process proceeds to step S30. For example, even if the connection destination devices of the detected device m and the detected device n are manufactured by a predetermined company, a case where the detected device n does not have the serial number of the connection destination device corresponds to (step S27; NO).

The controller 11 sets the IP addresses of the detected devices m acquired in step S15 or S18 to a variable va (step S31). The controller 11 sets, in a variable vb, the IP addresses of the connection destination devices of the detected device n acquired in step S30 (step S32).

After performing step S29 or S32, the controller 11 determines whether or not va=vb (step S33). va=vb (YES in step S33), the controller 11 registers the combination of the detected devices m and n as one printing system (step S34). In step S34, the one printing system to be registered is added to the registration information of the color management program P0 stored in the storage section 13. However, when the same printing system in the registration information is duplicated by the addition of one printing system, the one printing system is not added. Information indicating that the detected devices m and n form one printing system and the IP addresses (device-specific information) of the detected devices m and n are registered in the registration information.

The controller 11 determines whether or not m=p (step S35). If m/p (step S35; NO), the controller 11 increments the variable m by +1 (step S36). The processing proceeds to step S24.

When va≠vb is satisfied (step S33; NO), the controller 11 determines whether or not n=p is satisfied (step S37). When n≠p (step S37; NO), the controller 11 increments the variable n by +1 (step S38). The processing proceeds to step S25.

In a case of n=p (step S37; YES), the controller 11 determines whether or not there is an input of the IP of a connection destination device of the detected device m from the user through the operation part 12 (step S39). At the stage of step S37; YES, not all of the detected devices n are the connection destination devices of the detected device m. However, for example, there may be a case where the detected device n does not have the device-specific information of the connection destination device, or a case where the connection destination device of the detected device m is powered off. In these cases, the user can specify the connection destination device of the detected device m by manually inputting the IP address of the connection destination device of the detected device m. Therefore, the detected device m and the connection destination device specified and input can constitute one printing system.

When the IP addresses are input (step S39; YES), the controller 11 registers the combination of the detected device m and the connection destination device as one printing system (step S40). In step S40, the connection destination device to be registered is the connection destination device whose IP address has been input in step S39. Furthermore, the one printing system to be registered is added to the registration information of the color management program P0 stored in the storage section 13. However, when the same printing system in the registration information is duplicated by the addition of one printing system, the one printing system is not added. Registered in the registration information are information to the effect that the detected device m and the connection destination device form one printing system, the IP address (and the device-specific information) of the detected device m, and the IP address of the connection destination device. The processing proceeds to step S35.

When the IP addresses are not input (step S39; NO), the controller 11 registers only the detected device m (step S41). In step S41, the detected device m to be registered is added to the registration information of the color management program P0 stored in the storage section 13. Information indicating that the detected device m is a single device and the IP address (device-specific information) of the detected device m are registered in the registration information. The processing proceeds to step S35.

If m=p holds (step S35; YES), the controller 11 displays the registration information on the display part 14 (step S42). In step S42, for example, a registration information display screen 500 shown in FIG. 8 is displayed. The registration information display screen 500 is window information in a table format having columns of system number, image forming apparatus image, product name, connection state, and IP addresses.

The system number is an identification number indicating a registered printing system. The image forming apparatus image is image data of an image forming apparatus of the printing system of the system number. The product name is a product name of the printing system of the system number. The connection state is state information of connection of each device of the printing system of the system number to the communication network N1. The IP address is an IP address of each device of the printing system of the system number. The system number, the image forming apparatus image, and the product name are based on, for example, information of the printing system stored in advance in the storage section 13 of the PC10. For example, information corresponding to the registered printing system (system number, image forming apparatus image, product name) is extracted from the information on the printing system and included in the registration information display screen 500.

The registration information display screen 500 includes information of the registered printing system A and printing system B. The printing system A includes, for example, an external controller 20A and an image forming apparatus 30A. The printing system B includes, for example, an external controller 20B and an image forming apparatus 30B. Note that the registration information display screen 500 may be configured to include information on a single device (image forming apparatus) registered in step S41.

As shown in FIG. 7, the controller 11 refers to the registration information stored in the storage section 13, and selects one unselected printing system in the registration information (step S43). The controller 11 acquires the version information of each device of the printing system selected in step S43 (step S44). The version information of each device is version information of a control program of each device.

For example, the controller 11 reads and acquires the version information of each device of the printing system under selection of the registration information stored in the storage section 13 of the PC10. Alternatively, the controller 11 requests, receives, and acquires the version information from each device of the selected printing system via the communication section 15.

The controller 11 acquires, via the communication section 15, the latest version information of each device from, for example, a server of the manufacturer of the printing system being selected (step S45). In step S45, the controller 11 compares, in the selected printing system, the acquired latest version information of each device with the version information of each device acquired in step S44. In step S45, the controller 11 further determines, from the comparison result, whether or not the version information of all the devices of the selected printing system is the latest.

In a case where there is a device whose version information is not the latest (step S45; NO), the controller 11 determines whether or not there is an unsupported function with the version information that is not the latest (step S46). An unsupported function is a function that is not supported by the non-latest version information among functions supported by the latest versions of the respective devices of the selected printing system. If there is an unsupported function (YES in step S46), the controller 11 sets the unsupported function in all the devices of the selected printing system to invalid (step S47). The controller 11 determines, based on the combination of the version information of the devices of the selected printing system, whether the printing system is likely to operate abnormally (step S48). When there is no unsupported function (step S46; NO), the process proceeds to step S48.

If there is a possibility of an abnormal operation (step S48; YES), the controller 11 sets the registration of the selected printing system to invalid (step S49). In step S49, for example, information on the printing system being selected is set to be invalid on the registration information. The controller 11 displays, on the display part 14, information prompting the user to upgrade the version of a device whose version information is not the latest among the selected printing systems (step S50). If there is no possibility of an abnormal operation (step S48; NO), the process proceeds to step S50.

The controller 11 determines whether all the printing systems in the registration information have been selected in step S41 (step S51). In a case where the version information of all the devices is the latest (step S45; YES), the process proceeds to step S51. If not all the printing systems have been selected (step S51; NO), the process moves to step S43. If all the printing systems have been selected (step S51; YES), the device registration processing ends.

As described above, according to the present embodiment, the PC10 includes the controller 11. A controller 11 detects a plurality of printing devices connected to a communication network N1, and registers the plurality of detected devices directly connected to each other as one printing system. The management system 1 includes a PC10 and a plurality of devices connected to the communication network N1.

Therefore, a plurality of printing devices on the communication network N1 can be registered as one printing system and can be integrally managed by one application. The application is a color management program P0.

The controller 11 acquires information on each device from the detected plurality of devices and registers the detected plurality of devices as one printing system on the basis of the acquired information on each device. The information on each device includes device-specific information on each device and device-specific information on a connection destination device of each device. The controller 11 determines, from the acquired device-specific information on the devices, whether the detected devices constitute a single printing system. Therefore, it is possible to easily and reliably determine and register the devices configuring one printing system and the connection destination devices thereof.

When the device-specific information of the connection destination device of the second device corresponding to the first device cannot be acquired, the controller 11 acquires the IP address of the first device and the IP address of the connection destination device of the second device. The first device is a detected device m. The second device is a detected device n. Based on the acquired IP addresses of the respective devices, the controller 11 registers the first device and the second device as one printing system. Therefore, for example, even in a case where the first device and the second device form the same printing system but the device-specific information of the connection destination device of the second device cannot be obtained, the first device and the second device forming one printing system can be easily and reliably determined and registered.

The controller 11 changes the type of the information on each of the devices to be acquired, based on the type of each of the devices (manufactured by a predetermined company or another company). For example, when the type of each device is made by a predetermined company, a plurality of detected devices are registered as one printing system based on the serial number of each device. Further, for example, in a case where the type of each device is made by another company, a plurality of detected devices are registered as one printing system based on the IP address of each device. Therefore, it is possible to easily and reliably determine and register a plurality of devices constituting one printing system.

When information on the connection destination device of the first device cannot be acquired, the controller 11 receives an input for designating the connection destination device of the first device. The controller 11 registers the first device and the specified and input connection destination device as one printing system. Therefore, even when the device-specific information of the connection destination device of the first device cannot be acquired, the first device and the specified and input connection destination device can be registered as one printing system.

The controller 11 acquires the version information of each device of the registered printing system. On the basis of the acquired version information, the controller 11 sets the invalidity of the prescribed function of the printing system and the invalidity of the registration of the printing system. Therefore, a predetermined function that cannot be executed because the version information of at least one device of the registered printing system is old can be set to be invalid, and an abnormality can be prevented. In addition, the registration of the printing system in which the abnormal operation may occur because the version information of at least one device of the registered printing system is old can be set to be invalid, and the abnormal operation can be prevented.

In the above description, an example in which an HDD or an SSD is used as a computer-readable medium of the program according to the present invention has been disclosed, but the present invention is not limited to this example. As other computer-readable media, a nonvolatile memory such as a flash memory and a portable recording medium such as a CD-ROM can be applied. Further, as a medium for providing data of the program according to the present invention via a communication line, a carrier wave is also applied to the present invention.

Note that the description in the above embodiment is an example of the information processing apparatus, the management system, the device management method, and the recording medium according to the present invention, and the present invention is not limited thereto.

For example, although the printing devices configuring the printing system are the external controller and the image forming apparatus in the above-described embodiment, they are not limited thereto. The printing system may be configured to include the external controller, the image forming apparatus, and another printing device such as the inspection device. The inspection device is a device that reads an image of a printed product on which the image is formed by the image forming apparatus. The inspection device compares the read image data with the original image data or the chart, and generates correction data based on a comparison result. The correction data is fed back to the external controller and/or the image forming apparatus, and is used for correction of color, density, and the like for printing.

Furthermore, in the above-described embodiment, in steps S27 to S28 and S32 of the device registration processing, the controller 11 compares the serial numbers of the detected device m and the connection destination device of the detected device n.

The controller 11 registers the detected devices m and n as one printing system according to the comparison result. However, it is not limited to this configuration. For example, in the case of the device registration processing (step S26; YES), the controller 11 may be configured to acquire the device-specific information (or the IP addresses) of the connection destination devices of the detected device m. The controller 11 registers the detected device m and the connection destination device that has acquired the device-specific information (or the IP address) as one printing system.

In the above-described embodiment, in steps S29 to S32 of the device registration processing, the controller 11 compares the IP addresses of the detected device m and the connection destination device of the detected device n. The controller 11 registers the detected devices m and n as one printing system according to the comparison result. However, it is not limited to this configuration. For example, in the case of the device registration processing (step S26; NO), the controller 11 may be configured to receive, via the operation part 12, an input for specifying the IP addresses of the connection destination devices of the detected device m. The controller 11 registers the detected device m and the specified and input connection destination device as one printing system. In addition, the detailed configuration and the detailed operation of the management system 1 in the present embodiment described above can also be appropriately modified without departing from the spirit and scope of the present invention.

According to the embodiment, a plurality of printing devices on a communication network can be managed as one printing system.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2023-184536 filed on Oct. 27, 2023 is incorporated herein by reference in its entirety.

What is claimed is:

1. An information processing apparatus comprising a hardware processor that:
detects a plurality of devices for printing connected to a communication network; and
registers the detected plurality of devices directly connected to each other as one printing system.

2. The information processing apparatus according to claim 1, wherein the hardware processor acquires information of each of the devices from the detected plurality of devices and registers the detected plurality of devices as one printing system based on the acquired information of each of the devices.

3. The information processing apparatus according to claim 2, wherein the information of each of the devices includes device-specific information of each of the devices and device-specific information of a connection destination device of each of the devices.

4. The information processing apparatus according to claim 3, wherein the hardware processor determines, from the acquired device-specific information of each of the devices, whether or not the detected plurality of devices form one printing system.

5. The information processing apparatus according to claim 3, wherein the hardware processor is not able to acquire device-specific information of a connection destination device of a second device corresponding to a first device, and the hardware processor acquires network address information of the first device and network address information of the connection destination device and registers the first device and the second device as one printing system based on the acquired network address information of each of the devices.

6. The information processing apparatus according to claim 2, wherein the hardware processor switches a type of information of each of the devices to be acquired based on a type of each of the devices.

7. The information processing apparatus according to claim 1, wherein the hardware processor is not able to acquire information of a connection destination device of a first device, and the hardware processor receives a designation input of the connection destination device of the first device and registers the first device and the connection destination device for which the designation input has been performed as one printing system.

8. The information processing apparatus according to claim 1, wherein the hardware processor acquires version information of each of the devices of the registered printing system and sets at least one of invalidity of a predetermined function of the printing system and invalidity of registration of the printing system, based on the version information.

9. A management system comprising:
the information processing apparatus according to claim 1; and
a plurality of devices connected to the communication network.

10. A device registration method comprising:
detecting a plurality of devices for printing connected to a communication network; and
registering the detected plurality of devices directly connected to each other as one printing system.

11. A non-transitory recording medium storing a computer readable program causing a computer to perform:
detecting a plurality of devices for printing connected to a communication network; and
registering the detected plurality of devices directly connected to each other as one printing system.

12. The recording medium according to claim 11, wherein the computer acquires information of each of the devices from the detected plurality of devices and registers the detected plurality of devices as one printing system based on the acquired information of each of the devices.

13. The recording medium according to claim 12, wherein the information of each of the devices includes device-specific information of each of the devices and device-specific information of a connection destination device of each of the devices.

14. The recording medium according to claim 13, wherein the computer determines, from the acquired device-specific information of each of the devices, whether or not the detected plurality of devices form one printing system.

15. The recording medium according to claim 13, wherein the computer is not able to acquire device-specific information of a connection destination device of a second device corresponding to a first device, and the computer acquires network address information of the first device and network address information of the connection destination device and registers the first device and the second device as one printing system based on the acquired network address information of each of the devices.

16. The recording medium according to claim 12, wherein the computer switches a type of information of each of the devices to be acquired based on a type of each of the devices.

17. The recording medium according to claim 11, wherein the computer is not able to acquire information of a connection destination device of a first device, and the computer receives a designation input of the connection destination device of the first device and registers the first device and the connection destination device for which the designation input has been performed as one printing system.

18. The recording medium according to claim 11, wherein the program causes the computer to acquire version information of each of the devices of the registered printing system and set at least one of invalidity of a predetermined function of the printing system and invalidity of registration of the printing system, based on the version information.
